(19) United States
(12) Patent Application Publication
(10) Pub. No.: US 2023/0291794 A1
(43) Pub. Date: Sep. 14, 2023

(54) SYSTEMS, METHODS, AND STORAGE MEDIA FOR ORCHESTRATING A DISTRIBUTED GLOBAL COMPUTING CLUSTER MODEL AND INTERFACE

(71) Applicant: Section.io Incorporated, Boulder, CO (US)

(72) Inventors: Daniel Bartholomew, Louisville, CO (US); Gary Ritzer, Longmont, CO (US); Ivan Hamilton, Cumberland Reach (AU); Glenn Slaven, Berridale (AU); Jason Stangroome, Wamberal (AU)

(21) Appl. No.: 18/092,336

(22) Filed: Jan. 1, 2023

Related U.S. Application Data
(60) Provisional application No. 63/319,618, filed on Mar. 14, 2022.

(51) Int. Cl. H04L 67/101; H04L 67/1008

(52) U.S. Cl. CPC H04L 67/101; H04L 67/1008

(57) ABSTRACT

Systems, methods, and storage media for administering a distributed edge computing system using a computing platform are disclosed. Exemplary implementations may: identify a plurality of computing clusters running at least one workload; collect data from the plurality of computing clusters; aggregate the data from the plurality of computing clusters; access a model; reconcile, based at least in part on accessing the model, one or more of the data from the data store and state data for the at least one workload to create reconciled cluster data; receive one or more messages from a user device; and in response to receiving the one or more messages from the user device, provide at least a portion of the reconciled cluster data to the user device.

### CROSS-REFERENCE TO RELATED APPLICATIONS

The present application claims priority to U.S. Provisional Application No. 63/319,618, entitled “Systems, Methods, Computing Platforms, and Storage Media for Orchestrating a Distributed Global Computing Cluster for Edge Computing Utilizing a Global Cluster Edge Interface,” filed Mar. 14, 2022, the contents of which are incorporated herein by reference in their entirety and for all practical purposes.

### FIELD OF THE DISCLOSURE

The present disclosure generally relates to delivery of data using computer networks. More specifically, but without limitation, the present disclosure relates to systems, methods, and storage media for orchestrating a distributed global computing cluster model and interface using a computing platform.

### BACKGROUND

The recent era of computing has been referred to as cloud computing. Cloud computing refers to the use of commercial data centers to host applications. The commercial “cloud” data centers largely replaced on-premises data centers as previously built and maintained by larger companies. Cloud computing offers greater efficiency through specialization and economies of scale, and presents application owners, large and small, with a variety of economical options for hosting applications. Owners of applications can focus on the development, functioning, and deployment of their applications and defer operational aspects of the data center to specialists by purchasing the hosting services from cloud computing providers.

Content Delivery Networks (CDN) are geographically distributed networks of proxy servers, which were an early adaptation to the limitations of data center architecture and cloud computing. While CDNs enhance application performance, for instance, by storing copies of frequently-requested information (e.g., via caching) at nodes close to replicas of the application, they are simply a form of static deployment in the same manner as a typical cloud-hosted application.

Current trends in application hosting reflect a continued progression from cloud computing to edge computing. Edge computing is so named because the locations for hosting include many locations at the network “edge”, close to end users. Edge locations include traditional “hyper-scale” cloud facilities, small “micro” data facilities, which might be attached to telecommunications transceivers, and everything in-between. Distributing applications across a dynamic and diverse set of network nodes introduces new issues and complexities to application management. Current systems and methods for distributed edge computing systems lack scalability and flexibility in allowing developers to run workloads anywhere along the edge. Thus, there is a need for a refined distributed edge computing system that alleviates some of the challenges faced with legacy edge or CDN solutions.

The description provided in the background section should not be assumed to be prior art merely because it is mentioned in or associated with the background section. The background section may include information that describes one or more aspects of the subject technology.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

As described above, Content Delivery Networks (CDN) are geographically distributed networks of proxy servers, which were an early adaptation to the limitations of data center architecture and cloud computing. In some cases, CDNs enhance application performance by storing copies of frequently-requested information (e.g., via caching) at nodes close to replicas of the application. This network of caches reduces transmission time by servicing end user requests from caches near them in the network. However, CDNs are simply a form of static deployment in the same manner as a typical cloud-hosted application, since a CDN replicates parts of the application and places them in strategic locations, but all deployments are essentially pre-determined and fixed. Furthermore, CDNs provide locked down and limited feature sets and provide limited delivery location options.

In some cases, edge computing relates to enabling and managing the increasingly complex deployment environment to optimize application performance. Current trends in application hosting reflect a continued progression from cloud computing to edge computing. However, the state of edge computing is challenged since CDNs integrate poorly with modern application development workflows. For instance, edge computing requires different methods of application development and operations. In some circumstances, edge applications also often emphasize more modular and distributed design patterns.

Existing techniques for deployments present a number of challenges. One means of maximizing responsiveness of an application is to run a maximum number of copies in a maximum number of facilities, which is not cost effective. An alternative option is to run the application in an optimal set of locations subject to objectives and constraints such as cost, performance, and others. A number of diverse hosting locations are emerging to meet these needs, creating opportunities for the application landscape of the future, but the tools for operationalizing them are lacking.

A simple example of dynamic edge computing is a large public sporting event, where a particular related application (e.g., social media application, video sharing application, etc.) may best serve users by running in micro-servers installed in the arena, e.g., 5G telecommunications arrays, radically reducing transmission times for attendees. However, such facilities usually have very high costs of use. After the event is over and the audience has dispersed, the arena locations may no longer be beneficial nor cost-effective. In many cases, the instances of the applications are removed from the arena locations and deployed at another data facility that offers appropriate cost and performance for the event level of user traffic. Similar dynamic deployments can occur elsewhere for the same application based on local conditions by creating and managing multiple instances of the application. It is also possible that some critical functions of the application can be hosted in a more secure commercial data center, while other parts of the application can be hosted at the edge.

The following co-owned U.S. Pat. No. 17,206,608, entitled “Systems, Methods, Computing Platforms, and Storage Media for Administering a Distributed Edge Computing System Utilizing an Adaptive Edge Engine,” filed Mar. 19, 2021, and now issued as U.S. Pat. No. 11,277,344 is useful in understanding the present disclosure and its embodiments and is incorporated herein by reference in its entirety and for all practical purposes.

Coincident with the timeline of the rise and evolution of cloud and edge computing has been the advent of containerized applications. Software containers facilitate the development and deployment of applications by providing an abstracted interface between the application and the operating systems of the underlying computing hardware. An essential element of edge computing is containerization of the applications so that management and orchestration of applications is more flexible and tractable.

With the rise of containerized application development, we also see the rise of container orchestration systems. These systems create a virtual computing cluster within one or more virtual or physical servers. A virtual cluster consists of several management “nodes” which manage and operate the cluster and additional server “nodes” that host applications. Computing clusters (real or virtual) allow an application developer to treat an integrated collection of servers as if they were just one server.

KUBERNETES is one of many container orchestration platforms that enables developers to define their containers, deploy them to a local cluster, and manage various aspects of the deployment through command-line tools. The challenge of edge computing is to enable this same level of abstraction and simplified workflow while accessing the benefits of a simultaneous multitude of globally-distributed edge clusters.

A more efficient solution for proliferating edge computing may comprise running the application in an optimal set of locations subject to both cost and performance goals and relevant constraints. While a number of diverse hosting locations are emerging to meet needs and create opportunities for the application landscape of the future, the tools for operationalizing them are lacking.

Edge computing deals explicitly with enabling and managing the increasingly complex deployment environment to optimize application performance. Distributing applications across a dynamic and diverse set of physical locations introduces new issues and complexities to application management. However, current techniques for distributed edge computing systems lack an integrated means of handling a large portfolio of deployment clusters.

Broadly, aspects of the present disclosure are directed to techniques to optimize and expedite services and delivery of content using distributed computing resources and networks, which enables application developers to run workloads (or applications) anywhere along the edge with the simplicity of running a workload on a single server.

As used herein, the terms “workload”, “application”, and “deployment object” may be used interchangeably throughout the disclosure and may be used to refer to any of a software application, a mobile application, a web application, and a containerized application, to name a few non-limiting examples. Additionally, the terms “servers” and “nodes” may also be used interchangeably throughout the disclosure. As used herein, the terms “cluster”, “local cluster”, “computing cluster” may be used interchangeably throughout the disclosure. In some cases, a cluster may refer to a collection of networked servers or nodes. Further, a cluster may be deployed at a data center (e.g., a single data center), or across one or more data centers.

One aspect of the present disclosure relates to a system configured for administering a distributed edge computing system using a computing platform. The system may include one or more hardware processors configured by machine-readable instructions. The processor(s) may be configured to identify a plurality of computing clusters running at least one workload. The plurality of computing clusters may be associated with an orchestration system. The processor(s) may be configured to collect data from the plurality of computing clusters. The data may include workload information for the at least one workload. The processor(s) may be configured to aggregate the data from the plurality of computing clusters. The aggregating may further include storing the data to a data store. The processor(s) may be configured to access a model, such as a Global Cluster Model or GCM. The processor(s) may be configured to reconcile, based at least in part on accessing the model, one or more of the data from the data store and state data for the at least one workload to create reconciled cluster data. The processor(s) may be configured to receive one or more messages from a user device. The one or more messages may include one or more of a query request and a command. The processor(s) may be configured to, in response to receiving the one or more messages from the user device, provide at least a portion of the reconciled cluster data to the user device.

In some implementations of the system, the reconciling to create the reconciled cluster data may include translating, based at least in part on accessing the model, the data collected from the plurality of computing clusters and the state data into a single source of truth (SSOT) for a corresponding workload state for the at least one workload across the plurality of computing clusters. As an example, reconciling may comprise determining a workload state (e.g., Ready or Not Ready status) for a workload running across the plurality of computing clusters. In such cases, if the workload state for at least one of the plurality of computing clusters comprises a Not Ready status, the SSOT may comprise a Not Ready status. In another example, the model may specify that the SSOT should be based on the workload state across a majority of the plurality of computing clusters. For instance, if the workload state for three (3) out of four (4) computing clusters comprises a Ready Status, the SSOT may comprise a Ready status.

In some implementations of the system, the model may be used for synthesizing information corresponding to the plurality of computing clusters and the orchestration system into a global construct. In some implementations of the system, the information may include at least the data collected from the plurality of computing clusters and data specific to the orchestration system. In some implementations of the system, the global construct may be utilized to generate the SSOT of the corresponding workload state for the at least one workload across the plurality of computing clusters.

In some implementations of the system, the computing platform may be electronically, logically, or communicatively coupled to the orchestration system associated with the plurality of computing clusters and a global cluster interface (GCI), wherein the GCI includes at least the data store and an application programming interface (API) for communications with the user device.

In some implementations of the system, prior to providing at least a portion of the reconciled cluster data to the user device, the processor(s) may be configured to identify a target recipient for a first one of the one or more messages. In some implementations of the system, the target recipient may include one of the orchestration system, at least one of the plurality of computing clusters, the computing platform, or the data store.

In some implementations of the system, the processor(s) may be configured to proxy the first one of the one or more messages to the target recipient. In some implementations of the system, proxying the first one of the one or more messages may further include translating the first one of the one or more messages into a form that is interpretable by the target recipient. In some implementations of the system, proxying the first one of the one or more messages may further include relaying the translated first one of the one or more messages to the target recipient.

In some implementations of the system, the processor(s) may be configured to receive a response from a corresponding one of the orchestration system, the at least one of the plurality of computing clusters, the data store, or the computing platform (e.g., distributed computing platform 352 in FIG. 3). In some implementations of the system, the response may include at least information used to create the reconciled cluster data.

Another aspect of the present disclosure relates to a method for administering a distributed edge computing system using a computing platform. The method may include identifying a plurality of computing clusters running at least one workload. The plurality of computing clusters may be associated with an orchestration system. The method may include collecting data from the plurality of computing clusters. The data may include workload information for the at least one workload. The method may include aggregating the data from the plurality of computing clusters. The aggregating may further include storing the data to a data store. The method may include accessing a model. The method may include reconciling, based at least in part on accessing the model, one or more of the data from the data store and state data for the at least one workload to create reconciled cluster data. The method may include receiving one or more messages from a user device. The one or more messages may include one or more of a query request and a command. The method may include, in response to receiving the one or more messages from the user device, providing at least a portion of the reconciled cluster data to the user device.

In some implementations of the method, the reconciling to create the reconciled cluster data may include translating, based at least in part on accessing the model, the data collected from the plurality of computing clusters and the state data into a single source of truth (SSOT) for a corresponding workload state for the at least one workload across the plurality of computing clusters.

In some implementations of the method, the model may be used for synthesizing information corresponding to the plurality of computing clusters and the orchestration system into a global construct. In some implementations of the method, the information may include at least the data collected from the plurality of computing clusters and data specific to the orchestration system. In some implementations of the method, the global construct may be utilized to generate the SSOT of the corresponding workload state for the at least one workload across the plurality of computing clusters.

In some implementations of the method, the computing platform may be electronically, logically, or communicatively coupled to the orchestration system associated with the plurality of computing clusters, and a global cluster interface (GCI), wherein the GCI includes at least the data store and an application programming interface (API) for communications with the user device.

In some implementations of the method, prior to providing at least a portion of the reconciled cluster data to the user device, the method may include identifying a target recipient for a first one of the one or more messages. In some implementations of the method, the target recipient may include one of the orchestration system, at least one of the plurality of computing clusters, the computing platform, or the data store. In some implementations, the method may include proxying the first one of the one or more messages to the target recipient prior to providing at least a portion of the reconciled cluster data to the user device.

In some implementations of the method, proxying the first one of the one or more messages may further include translating the first one of the one or more messages into a form that is interpretable by the target recipient. In some implementations of the method, proxying the first one of the one or more messages may further include relaying the translated first one of the one or more messages to the target recipient.

In some implementations, the method may include receiving a response from a corresponding one of the orchestration system, the at least one of the plurality of computing clusters, the data store, or the computing platform. In some implementations of the method, the response may include at least information used to create the reconciled cluster data.

Yet another aspect of the present disclosure relates to a non-transient computer-readable storage medium having instructions embodied thereon, the instructions being executable by one or more processors to perform a method for administering a distributed edge computing system using a computing platform. The method may include identifying a plurality of computing clusters running at least one workload. The plurality of computing clusters may be associated with an orchestration system. The method may include collecting data from the plurality of computing clusters. The data may include workload information for the at least one workload. The method may include aggregating the data from the plurality of computing clusters. The aggregating may further include storing the data to a data store. The method may include accessing a model. The method may include reconciling, based at least in part on accessing the model, one or more of the data from the data store and state data for the at least one workload to create reconciled cluster data. The method may include receiving one or more messages from a user device. The one or more messages may include one or more of a query request and a command. The method may include, in response to receiving the one or more messages from the user device, providing at least a portion of the reconciled cluster data to the user device.

In some implementations of the computer-readable storage medium, the reconciling to create the reconciled cluster data may include translating, based at least in part on accessing the model, the data collected from the plurality of computing clusters and the state data into a SSOT for a corresponding workload state for the at least one workload across the plurality of computing clusters.

In some implementations of the computer-readable storage medium, the model may be used for synthesizing information corresponding to the plurality of computing clusters and the orchestration system into a global construct. In some implementations of the computer-readable storage medium, the information may include at least the data collected from the plurality of computing clusters and data specific to the orchestration system. In some implementations of the computer-readable storage medium, the global construct may be utilized to generate the SSOT of the corresponding workload state for the at least one workload across the plurality of computing clusters.

In some implementations of the computer-readable storage medium, the computing platform may be electronically, logically, or communicatively coupled to the orchestration system associated with the plurality of computing clusters, and a global cluster interface (GCI), wherein the GCI includes at least the data store and an application programming interface (API) for communications with the user device.

In some implementations of the computer-readable storage medium, prior to providing at least a portion of the reconciled cluster data to the user device, the method may include identifying a target recipient for a first one of the one or more messages. In some implementations of the computer-readable storage medium, the target recipient may include one of the orchestration system, at least one of the plurality of computing clusters, the computing platform, or the data store. In some implementations of the computer-readable storage medium, the method may include proxying the first one of the one or more messages to the target recipient prior to providing at least a portion of the reconciled cluster data to the user device.

In some implementations of the computer-readable storage medium, proxying the first one of the one or more messages may further include translating the first one of the one or more messages into a form that is interpretable by the target recipient. In some implementations of the computer-readable storage medium, proxying the first one of the one or more messages may further include relaying the translated first one of the one or more messages to the target recipient.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured for orchestrating a distributed global computing cluster model and interface using a computing platform, in accordance with various aspects of the disclosure.

FIG. 2A illustrates a method for orchestrating a distributed global computing cluster model and interface using a computing platform, in accordance with various aspects of the disclosure.

FIG. 2B illustrates a method for orchestrating a distributed global computing cluster model and interface using a computing platform, in accordance with various aspects of the disclosure.

FIG. 2C illustrates a method for orchestrating a distributed global computing cluster model and interface using a computing platform, in accordance with various aspects of the disclosure.

FIG. 2D illustrates a method for orchestrating a distributed global computing cluster model and interface using a computing platform, in accordance with various aspects of the disclosure.

FIG. 3 shows a block diagram of a system for orchestrating a distributed global computing cluster model and interface using a computing platform, in accordance with various aspects of the disclosure.

FIG. 4 shows another block diagram of a system for orchestrating a distributed global computing cluster model and interface using a computing platform, in accordance with various aspects of the disclosure.

FIG. 5 illustrates a diagrammatic representation of a computer system configured for orchestrating a distributed global computing cluster model and interface using a computing platform, in accordance with various aspects of the disclosure.

### DETAILED DESCRIPTION

In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or devices. Accordingly, example aspects may take the form of a hardware implementation, a software implementation, or an implementation combining software and hardware aspects. The following detailed description is therefore not to be taken in a limiting sense, and the scope of the present disclosure is defined by the appended claims and their equivalents.

The words “for example” is used herein to mean “serving as an example, instant, or illustration.” Any embodiment described herein as “for example” or any related term is not necessarily to be construed as preferred or advantageous over other embodiments. Additionally, a reference to a “device” is not meant to be limiting to a single such device. It is contemplated that numerous devices may comprise a single “device” as described herein.

The embodiments described below are not intended to limit the invention to the precise form disclosed, nor are they intended to be exhaustive. Rather, the embodiment is presented to provide a description so that others skilled in the art may utilize its teachings. Technology continues to develop, and elements of the described and disclosed embodiments may be replaced by improved and enhanced items, however the teaching of the present disclosure inherently discloses elements used in embodiments incorporating technology available at the time of this disclosure.

The detailed descriptions which follow are presented in part in terms of algorithms and symbolic representations of operations on data within a computer memory wherein such data often represents numerical quantities, alphanumeric characters or character strings, logical states, data structures, or the like. A computer generally includes one or more processing mechanisms for executing instructions, and memory for storing instructions and data.

When a general-purpose computer has a series of machine-specific encoded instructions stored in its memory, the computer executing such encoded instructions may become a specific type of machine, namely a computer particularly configured to perform the operations embodied by the series of instructions. Some of the instructions may be adapted to produce signals that control operation of other machines and thus may operate through those control signals to transform materials or influence operations far removed from the computer itself. These descriptions and representations are the means used by those skilled in the data processing arts to convey the substance of their work most effectively to others skilled in the art.

The term algorithm as used herein, and generally in the art, refers to a self-consistent sequence of ordered steps that culminate in a desired result. These steps are those requiring manipulations of physical quantities. Usually, though not necessarily, these quantities take the form of electrical or magnetic pulses or signals capable of being stored, transferred, transformed, combined, compared, and otherwise manipulated. It is often convenient for reasons of abstraction or common usage to refer to these signals as bits, values, symbols, characters, display data, terms, numbers, or the like, as signifiers of the physical items or manifestations of such signals. It should be borne in mind, however, that all of these and similar terms are to be associated with the appropriate physical quantities and are merely used here as convenient labels applied to these quantities.

Some algorithms may use data structures for both inputting information and producing the desired result. Data structures facilitate data management by data processing systems and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation. By changing the organization and operation of data structures and the algorithms for manipulating data in such structures, the fundamental operation of the computing system may be changed and improved.

In the descriptions herein, operations and manipulations are often described in terms, such as comparing, sorting, selecting, or adding, which are commonly associated with mental operations performed by a human operator. However, it should be understood that these terms are employed to provide a clear description of an embodiment of the present disclosure, and no such human operator is necessary.

This requirement for machine implementation for the practical application of the algorithms is understood by those persons of skill in this art as not a duplication of human thought, rather as significantly more than such human capability. Useful machines for performing the operations of one or more embodiments of the present invention include general purpose digital computers or other similar devices. In all cases, the distinction between the method operations in operating a computer and the method of computation itself should be recognized. One or more embodiments of the present disclosure relate to methods and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher-level coding of the instructions that is interpreted to obtain the actual computer code. The software module may also include a hardware component, wherein some aspects of the algorithm are performed by the circuitry itself rather than a result of an instruction.

Some embodiments of the present disclosure rely on an apparatus for performing disclosed operations. This apparatus may be specifically constructed for the required purposes, or it may comprise a general purpose or configurable device, such as a computer selectively activated or reconfigured by a program comprising instructions stored to be accessible by the computer. The algorithms presented herein are not inherently related to any particular computer or other apparatus unless explicitly indicated as requiring particular hardware. In some cases, the computer programs may communicate or interact with other programs or equipment through signals configured to particular protocols which may or may not require specific hardware or programming to accomplish. In particular, various general-purpose machines may be used with programs written in accordance with the teachings herein, or it may prove more convenient to construct more specialized apparatus to perform the required method steps. The required structure for a variety of these machines will be apparent from the description below.

In the following description, several terms which are used frequently have specialized meanings in the present context.

In the description of embodiments herein, frequent use is made of the terms server, client, and client/server architecture. In this context, a server and client are each instantiations of a set of functions and capabilities intended to support distributed computing. These terms are often used to refer to a computer or computing machinery, yet it should be appreciated that the server or client function is provided by machine execution of program instructions, threads, modules, processes, or applications. The client computer and server computer are often, but not necessarily, geographically separated, although the salient aspect is that client and server each perform distinct, but complementary functions to accomplish a task or provide a service. The client and server accomplish this by exchanging data, messages, and often state information using a computer network, or multiple networks. It should be appreciated that in a client/server architecture for distributed computing, there are typically multiple servers and multiple clients, and they do not map to each other and further there may be more servers than clients or more clients than servers. A server is typically designed to interact with multiple clients.

In networks, bi-directional data communication (i.e., traffic) occurs through the transmission of encoded light, electrical, or radio signals over wire, fiber, analog, digital cellular, Wi-Fi, or personal communications service (PCS) media, or through multiple networks and media connected by gateways or routing devices. Signals may be transmitted through a physical medium such as wire or fiber, or via wireless technology using encoded radio waves. Much wireless data communication takes place across cellular systems using second generation technology such as code-division multiple access (CDMA), time division multiple access (TDMA), the Global System for Mobile Communications (GSM), Third Generation (wideband or 3G), Fourth Generation (broadband or 4G), Fifth Generation (5G), personal digital cellular (PDC), or through packet-data technology over analog systems such as cellular digital packet data (CDPD).

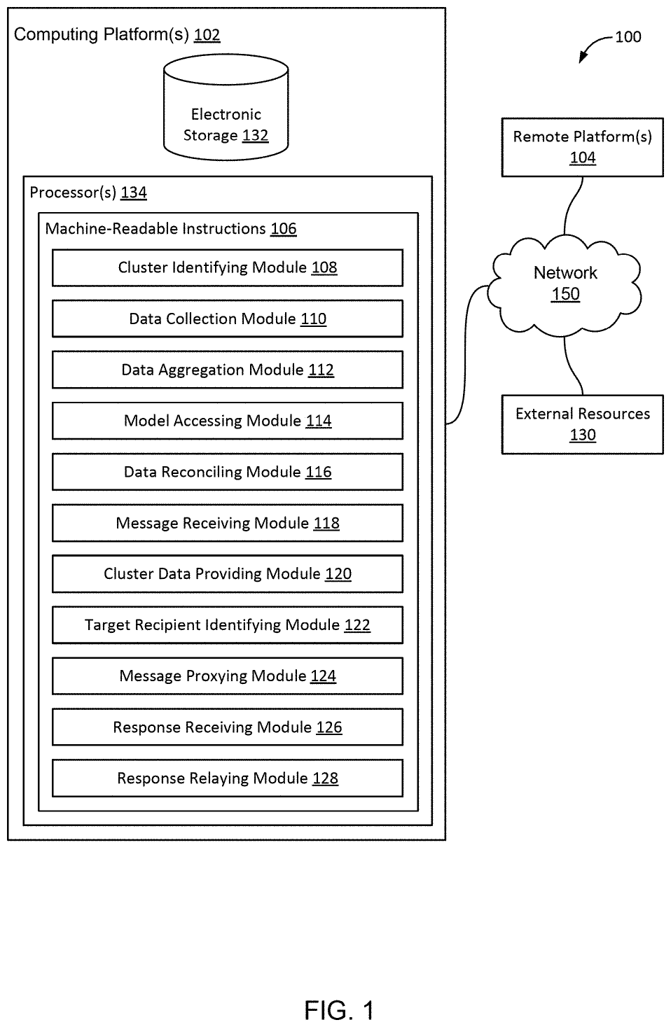

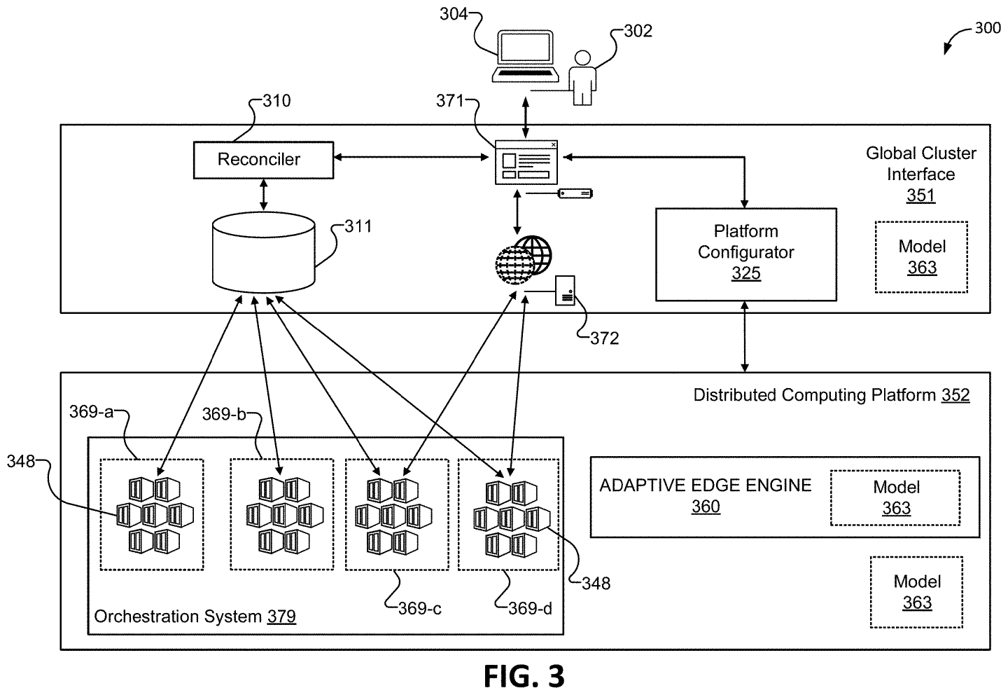

FIG. 1 illustrates a system 100 configured for orchestrating a distributed global computing cluster model and interface using a computing platform, according to various aspects of the present disclosure. Additionally, or alternatively, the system 100 is configured for administering a distributed edge computing system using a computing platform, according to various aspects of the disclosure. In some implementations, system 100 may include one or more computing platforms 102. Computing platform(s) 102 may be configured to communicate with one or more remote platforms 104 according to a client/server architecture, a peer-to-peer architecture, and/or other architectures. In some cases, the computing platform 102 may implement one or more aspects of the global cluster interface (GCI) 351, distributed computing platform 352, and/or adaptive edge engine (AEE) 360 described below in relation to FIG. 3. Remote platform(s) 104 may be configured to communicate with other remote platforms via computing platform(s) 102 and/or according to a client/server architecture, a peer-to-peer architecture, and/or other architectures. Users may access system 100 via remote platform(s) 104. In some examples, the terms “remote computing platform”, “remote platform”, “user device”, and “user equipment” may be used interchangeably throughout the disclosure. Some non-limiting examples of remote platform(s) include laptops, desktop computers, smartphones, and/or tablets. In some cases, the remote computing platform 104 may be similar or substantially similar to one or more of user device 304, orchestration system 379, node(s) 348, and/or computing cluster(s) 369 described below in relation to FIG. 3.

Computing platform(s) 102 may be configured by machine-readable instructions 106. Machine-readable instructions 106 may include one or more instruction modules. The instruction modules may include computer program modules. The instruction modules may include one or more of cluster identifying module 108, data collection module 110, data aggregation module 112, model accessing module 114, data reconciling module 116, message receiving module 118, cluster data providing module 120, target recipient identifying module 122, message proxying module 124, response receiving module 126, response relaying module 128, and/or other instruction modules. It should be noted that one or more of the instruction modules described herein may be optional. Alternatively, in some embodiments, a single instruction module may be utilized to effectuate the functions of a plurality of instruction modules.

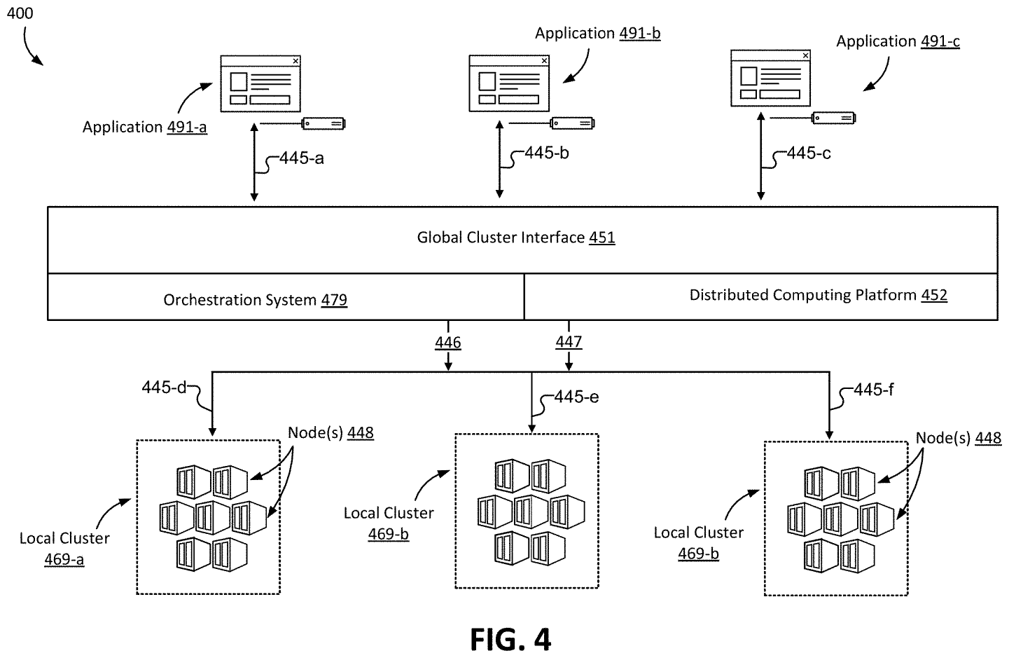

Cluster identifying module 108 may be configured to identify a plurality of computing clusters (e.g., shown as local clusters 469-a, 469-b, and 469-c in FIG. 4) running at least one workload. In some examples, the at least one workload may include a containerized application (e.g., shown as applications 491-a, 491-b, and 491-c in FIG. 4). The plurality of computing clusters may include a plurality of nodes or servers in communication over a network. For example, FIG. 4 illustrates a plurality of computing clusters 469, each comprising a plurality of nodes 448. Further, the computing clusters 469 are electronically, logically, and/or communicatively coupled to one or more of an orchestration system (e.g., orchestration system 479) and a distributed computing platform (e.g., distributed computing platform 452) over a network.

In some embodiments, the plurality of computing clusters may be associated with an orchestration system. Additionally, the container orchestration system (or simply orchestration system) schedules deployment of the at least one workload on one or more of the plurality of nodes or servers 448 of the plurality of computing clusters 469.

The computing platform, such as distributed computing platform 452 in FIG. 4, may be electronically, logically, or communicatively coupled to the orchestration system associated with the plurality of computing clusters, and a global cluster interface (GCI). In some embodiments, the GCI (e.g., shown as GCI 351 in FIG. 3, GCI 451 in FIG. 4) includes at least a data store and an application programming interface (API) for communications with the user device or remote computing platform 104. The orchestration system may be a container orchestration system, the container orchestration system including one or more of a logical construct and a software construct, further described below in relation to FIGS. 3 and/or 4.

Data collection module 110 may be configured to collect data from the plurality of computing clusters. The data may include workload information for the at least one workload (e.g., containerized application).

Data aggregation module 112 may be configured to aggregate the data from the one or more computing clusters. The aggregating may further include storing the data to a data store, such as data store 311 in FIG. 3.

Model accessing module 114 may be configured to access a model (also referred to as a global cluster model or GCM). The model may be used for synthesizing information corresponding to the plurality of computing clusters and the orchestration system into a global (or unified) construct. By way of non-limiting example, the model may include logic for interpreting one or more of data collected from the plurality of computing clusters, one or more of the logical constructs and/or software constructs of the container orchestration system, one or more objects associated with the container orchestration system, and one or more objects associated with the computer platform (e.g., distributed computing platform 352 in FIG. 3). In one non-limiting example, the container orchestration system may include a KUBERNETES container orchestration system, although other types of container orchestration systems (e.g., OPENSHIFT) known in the art are contemplated in different embodiments. In some cases, each one of the plurality of computing clusters may be running an instance of the at least one workload. In some instances, the model (e.g., GCM) may be configured to interpret the constructs of the KUBERNETES orchestration system, such as, but not limited to, namespaces, deployments, pods, and ingresses. For instance, KUBERNETES utilizes the concept of “pods”, where a “pod” wraps around an application container. Multiple “pods” can be collected into a “deployment”, and multiple “deployments” can be included within a “namespace”. KUBERNETES employs a logical construct called an “ingress” object to control routing rules enabling access to the orchestrated cluster. In some instances, the model (e.g., GCM) may be configured to interpret the constructs of the OPENSHIFT orchestration system, such as pods, deployments, projects, and routers. Some constructs of the OPENSHIFT orchestration system, such as “pods” and “deployments” are closely similar to the constructs in KUBERNETES of the same name. The OPENSHIFT project construct is similar to a KUBERNETES namespace, but with different and additional functionality. Similarly, OPENSHIFT routers address routing and access to OPENSHIFT clusters, while in KUBERNETES, this is handled by instances of the “ingress” construct. Thus, KUBERNETES and OPENSHIFT have their own (e.g., proprietary) logical constructs that are defined and implemented uniquely in their software and the instances of the GCM may be configured accordingly. In some examples, the GCI, such as GCI 351 in FIG. 3 of the present disclosure is configured to communicate/interact with these logical constructs, as appropriate to the container orchestration system in use, for instance, to query data about a “project” or “namespace”.

Data reconciling module 116 may be configured to reconcile, based at least in part on accessing the model, one or more of the data from the data store and state data for the at least one workload to create reconciled cluster data. The reconciling to create the reconciled cluster data may include translating, based at least in part on accessing the model, the data collected from the plurality of computing clusters and the state data into a SSOT for a corresponding workload state for the at least one workload across the plurality of computing clusters.

In one non-limiting example, the information may include at least the data collected from the plurality of computing clusters and/or data specific to the orchestration system (e.g., KUBERNETES, OPENSHIFT, to name two non-limiting examples). The global or unified construct may be utilized to generate the SSOT of the corresponding workload state for the at least one workload across the plurality of computing clusters. As an example, a query request may be received at the GCI from the user device, e.g., asking if the application is ready. This query request may be routed to all individual clusters (e.g., clusters 369 in FIG. 3) running the workload. Once a response (e.g., indicating whether the workload is Ready or Not Ready) is received from each of the individual clusters, the GCM is used for synthesizing the information corresponding to the plurality of computing clusters into a global construct. For instance, if at least one local cluster responds that the “application is Not Ready”, the GCI and/or GCM may interpret this as Not Ready across the plurality of computing clusters. In another non-limiting example, the GCI may receive one or more messages comprising a request for CPU resource usage information. Here, the GCM and/or GCI may aggregate the CPU resource usage (e.g., sum CPU usage across every cluster running the workload) for the plurality of computing clusters and output the result to the user.

Message receiving module 118 may be configured to receive one or more messages from a user device, where the one or more messages may include one or more of a query request and a command.

In some cases, the query request may include a request for a status update on the at least one workload running across the plurality of computing clusters. Additionally, or alternatively, the query request may include a request for computational resource usage information for the at least one workload running across the plurality of computing clusters.

In some examples, the command may include an instruction to delete at least one container associated with the containerized application. Alternatively, the command may include an instruction to update a configuration for at least one container associated with the containerized application, such as, but not limited to, a code update enabling a new feature in the workload, or an increase or decrease in the CPU or memory resource provisioning requirements to support desired workload performance.

Cluster data providing module 120 may be configured to, in response to receiving the one or more messages from the user device, provide at least a portion of the reconciled cluster data to the user device. In some cases, the cluster data providing module 120 may be configured to work in conjunction with one or more of the message receiving module 118 and a target recipient identifying module 122 to effectuate one or more aspects of the present disclosure. For example, prior to providing at least a portion of the reconciled cluster data to the user device, a target recipient identifying module 122 may be configured to identify a target recipient for a first one of the one or more messages. By way of non-limiting example, the target recipient may include one of the orchestration system (e.g., orchestration system 379), at least one of the plurality of computing clusters (e.g., computing clusters 369), the computing platform (e.g., distributed computing platform 352, remote computing platform 104), or the data store (e.g., data store 311).

Message proxying module 124 may be configured to proxy the first one of the one or more messages to the target recipient. In some implementations, proxying the first one of the one or more messages may further include translating the first one of the one or more messages into a form that is interpretable by the target recipient. Additionally, proxying the first one of the one or more messages may further include relaying the translated first one of the one or more messages to the target recipient.

Response receiving module 126 may be configured to receive a response from a corresponding one of the orchestration system, the at least one of the plurality of computing clusters, the data store, or the computing platform. In some examples, the response includes at least information used to create the reconciled cluster data.

Response relaying module 128 may be configured to relay the response to the user device. In some examples, the response relaying module 128 works in conjunction with one or more other instruction modules of the computing platform 102, such as, but not limited to, the message proxying module 124.

In some implementations, the at least one workload comprises a containerized application. In some implementations, the data collected from the plurality of computing clusters includes container data. As noted above, the data (e.g., collected from the plurality of computing clusters) may comprise workload information for the at least one workload. In some implementations, each one of the plurality of computing clusters is running an instance of the at least one workload. Furthermore, the query request may comprise a request for a status update on the at least workload running across the plurality of computing clusters. In one non-limiting example, the status update may include one of a Ready status or Not Ready status. In some cases, the query request comprises a request for computational usage information for the at least one workload running across the plurality of computing clusters. Additionally, or alternatively, the command (i.e., received via the one or more messages sent from the user device) comprises an instruction to delete at least one container associated with the containerized application. In other cases, the command comprises an instruction to update a configuration for at least one container associated with the containerized application. In one non-limiting example, the orchestration system associated with the containerized application includes a KUBERNETES container orchestration system. In some cases, the GCI is configured to directly interface with the plurality of computing clusters, according to the GCM, for one or more actions (e.g., changes to the workload configuration, information queries, etc.). As an example, the application or workload may comprise a node.JS application (essentially a website). If a new version (e.g., change in software code) is rolled out, the GCI is configured to push a new definition of the node.JS container. To ensure consistency between the plurality of clusters running the workload, the new workload configuration (i.e., associated with the updated node.JS container) is pushed out to all clusters running the workload.

In some implementations, computing platform(s) 102, remote computing platform(s) 104, and/or external resources 130 may be operatively linked via one or more electronic communication links. For example, such electronic communication links may be established, at least in part, via a network 150 such as the Internet and/or other networks. It will be appreciated that this is not intended to be limiting, and that the scope of this disclosure includes implementations in which computing platform(s) 102, remote platform(s) 104, and/or external resources 130 may be operatively linked via some other communication media.

A given remote platform 104 may include one or more processors configured to execute computer program modules. The computer program modules may be configured to enable an expert or user associated with the given remote platform 104 to interface with system 100 and/or external resources 130, and/or provide other functionality attributed herein to remote platform(s) 104. By way of non-limiting example, a given remote platform 104 and/or a given computing platform 102 may include one or more of a server, a desktop computer, a laptop computer, a handheld computer, a tablet computing platform, a NetBook, a Smartphone, a gaming console, and/or other computing platforms.

External resources 130 may include sources of information outside of system 100, external entities participating with system 100, and/or other resources. In some implementations, some or all of the functionality attributed herein to external resources 130 may be provided by resources included in system 100.

Computing platform(s) 102 may include electronic storage 132, one or more processors 134, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 132 may comprise non-transitory storage media that electronically stores information. The electronic storage media of electronic storage 132 may include one or both of system storage that is provided integrally (i.e., substantially non-removable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 132 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 132 may include one or more virtual storage resources (e.g., cloud storage, a virtual private network, and/or other virtual storage resources). Electronic storage 132 may store software algorithms, information determined by processor(s) 134, information received from computing platform(s) 102, information received from remote platform(s) 104, and/or other information that enables computing platform(s) 102 to function as described herein.

Processor(s) 134 may be configured to provide information processing capabilities in computing platform(s) 102. As such, processor(s) 134 may include one or more of a digital processor, an analog processor, a digital circuit designed to process information, an analog circuit designed to process information, a state machine, and/or other mechanisms for electronically processing information. Although processor(s) 134 is shown in FIG. 1 as a single entity, this is for illustrative purposes only. In some implementations, processor(s) 134 may include a plurality of processing units. These processing units may be physically located within the same device, or processor(s) 134 may represent processing functionality of a plurality of devices operating in coordination. Processor(s) 134 may be configured to execute modules 108, 110, 112, 114, 116, 118, 120, 122, 124, 126, and/or 128, and/or other modules. Processor(s) 134 may be configured to execute modules 108, 110, 112, 114, 116, 118, 120, 122, 124, 126, and/or 128, and/or other modules by software; hardware; firmware; some combination of software, hardware, and/or firmware; and/or other mechanisms for configuring processing capabilities on processor(s) 134. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, 118, 120, 122, 124, 126, and/or 128 are illustrated in FIG. 1 as being implemented within a single processing unit, in implementations in which processor(s) 134 includes multiple processing units, one or more of modules 108, 110, 112, 114, 116, 118, 120, 122, 124, 126, and/or 128 may be implemented remotely from the other modules. The description of the functionality provided by the different modules 108, 110, 112, 114, 116, 118, 120, 122, 124, 126, and/or 128 described below is for illustrative purposes, and is not intended to be limiting, as any of modules 108, 110, 112, 114, 116, 118, 120, 122, 124, 126, and/or 128 may provide more or less functionality than is described. For example, one or more of modules 108, 110, 112, 114, 116, 118, 120, 122, 124, 126, and/or 128 may be eliminated, and some or all of its functionality may be provided by other ones of modules 108, 110, 112, 114, 116, 118, 120, 122, 124, 126, and/or 128. As another example, processor(s) 134 may be configured to execute one or more additional modules that may perform some or all of the functionality attributed below to one of modules 108, 110, 112, 114, 116, 118, 120, 122, 124, 126, and/or 128.

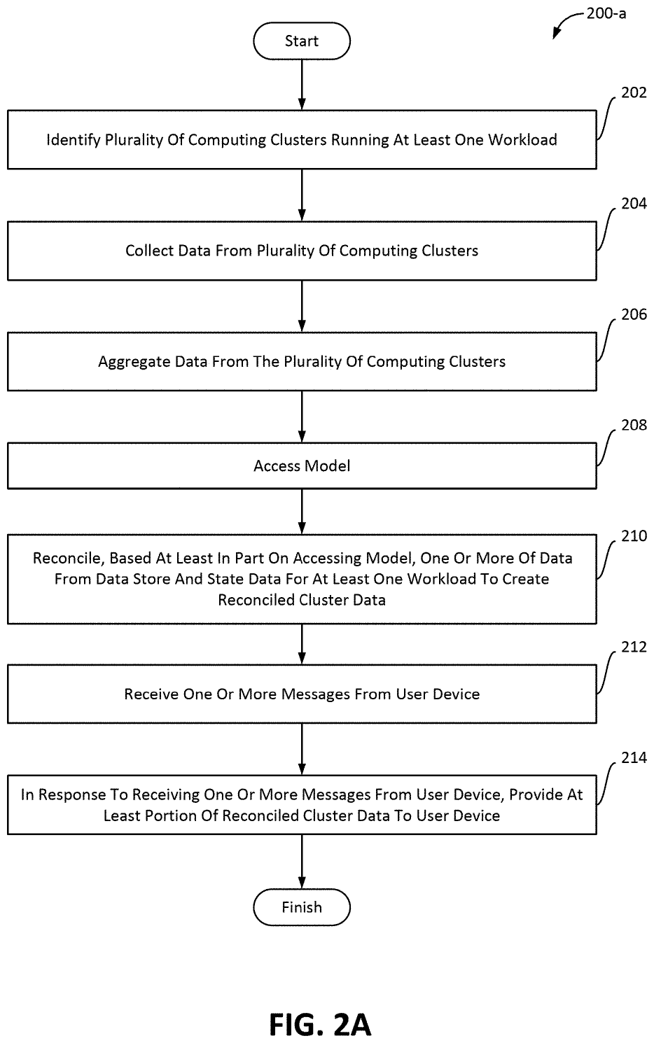

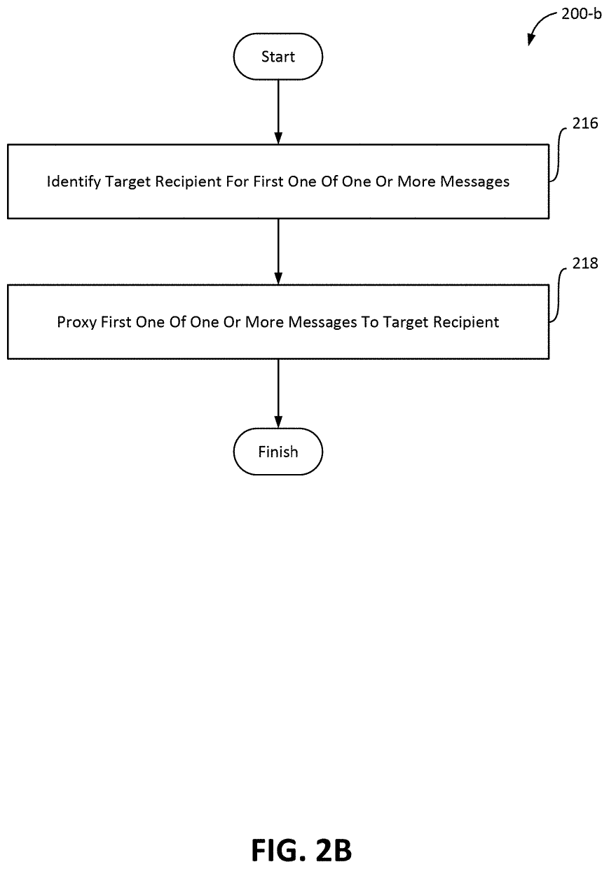

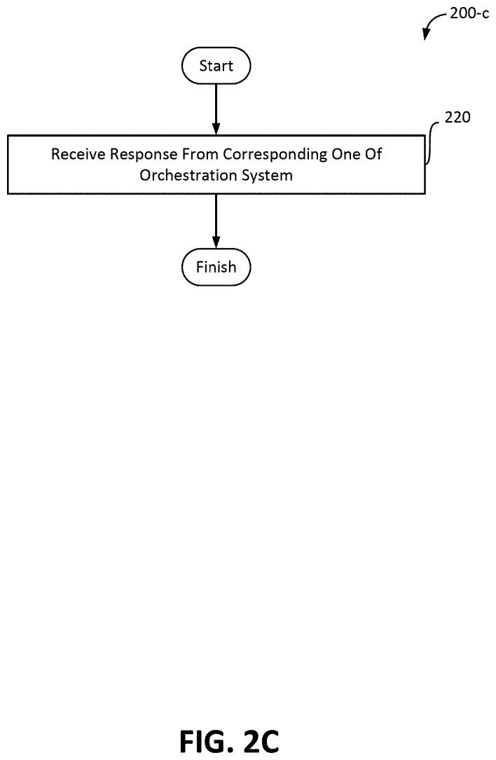

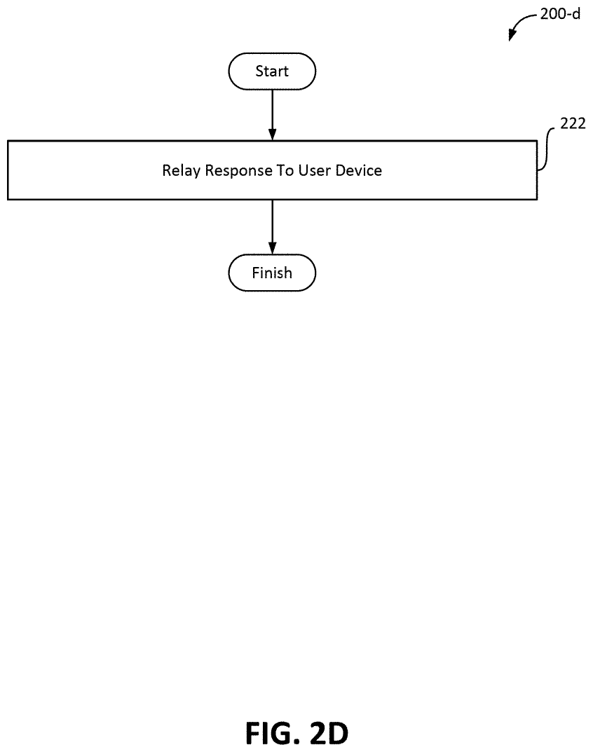

FIGS. 2A, 2B, 2C, and/or 2D illustrates method(s) 200 for orchestrating a distributed global computing cluster model and interface using a computing platform (e.g., distributed computing platform 352 in FIG. 3), in accordance with one or more implementations. Additionally, or alternatively, method(s) 200 are directed to administration of a distributed edge computing system using a computing platform, according to various aspects of the disclosure. The operations of method(s) 200 presented below are intended to be illustrative. In some implementations, method(s) 200 may be accomplished with one or more additional operations not described, and/or without one or more of the operations discussed. Additionally, the order in which the operations of method(s) 200 are illustrated in FIGS. 2A, 2B, 2C, and/or 2D and described below is not intended to be limiting.

In some implementations, method(s) 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method(s) 200 in response to instructions stored electronically on an electronic storage medium. The one or more processing devices may include one or more devices configured through hardware, firmware, and/or software to be specifically designed for execution of one or more of the operations of method 200.

FIG. 2A illustrates method 200-a for orchestrating a distributed global computing cluster model and interface using a computing platform (e.g., distributed computing platform 352 in FIG. 3), in accordance with one or more implementations.

A first operation 202 may include identifying a plurality of computing clusters running at least one workload. The plurality of computing clusters may be associated with an orchestration system (e.g., KUBERNETES container orchestration system). First operation 202 may be performed by one or more hardware processors configured by machine-readable instructions including a module that is the same as or similar to cluster identifying module 108, in accordance with one or more implementations.

A second operation 204 may include collecting data from the plurality of computing clusters. The data may include workload information for the at least one workload. Second operation 204 may be performed by one or more hardware processors configured by machine-readable instructions including a module that is the same as or similar to data collection module 110, in accordance with one or more implementations.

A third operation 206 may include aggregating the data from the plurality of computing clusters. The aggregating may further include storing the data to a data store, such as data store 311 in FIG. 3. Third operation 206 may be performed by one or more hardware processors configured by machine-readable instructions including a module that is the same as or similar to data aggregation module 112, in accordance with one or more implementations.

A fourth operation 208 may include accessing a model (e.g., a global cluster model or GCM). Fourth operation 208 may be performed by one or more hardware processors configured by machine-readable instructions including a module that is the same as or similar to model accessing module 114, in accordance with one or more implementations.

A fifth operation 210 may include reconciling, based at least in part on accessing the model, one or more of the data from the data store and state data for the at least one workload to create reconciled cluster data. Fifth operation 210 may be performed by one or more hardware processors configured by machine-readable instructions including a module that is the same as or similar to data reconciling module 116, in accordance with one or more implementations.

A sixth operation 212 may include receiving one or more messages from a user device. The one or more messages may include one or more of a query request and a command. Sixth operation 212 may be performed by one or more hardware processors configured by machine-readable instructions including a module that is the same as or similar to message receiving module 118, in accordance with one or more implementations.

A seventh operation 214 may include providing at least a portion of the reconciled cluster data to the user device in response to receiving the one or more messages from the user device. Seventh operation 214 may be performed by one or more hardware processors configured by machine-readable instructions including a module that is the same as or similar to cluster data providing module 120, in accordance with one or more implementations.

FIG. 2B illustrates method 200-b, in accordance with one or more implementations.

A first operation 216 may include identifying a target recipient for a first one of the one or more messages. The target recipient may include one of the orchestration system, at least one of the plurality of computing clusters, the computing platform, or the data store. First operation 216 may be performed by one or more hardware processors configured by machine-readable instructions including a module that is the same as or similar to target recipient identifying module 122, in accordance with one or more implementations.

A second operation 218 may include proxying the first one of the one or more messages to the target recipient. Second operation 218 may be performed by one or more hardware processors configured by machine-readable instructions including a module that is the same as or similar to message proxying module 124, in accordance with one or more implementations.

FIG. 2C illustrates method 200-c, in accordance with one or more implementations.

A first operation 220 may include receiving a response from a corresponding one of the orchestration system, the at least one of the plurality of computing clusters, the data store, or the computing platform. In some implementations, the response may include at least information used to create the reconciled cluster data. The first operation 220 may be performed by one or more hardware processors configured by machine-readable instructions including a module that is the same as or similar to response receiving module 126, in accordance with one or more implementations.

FIG. 2D illustrates method 200-d, in accordance with one or more implementations.

A first operation 222 may include relaying the response to the user device. First operation 222 may be performed by one or more hardware processors configured by machine-readable instructions including a module that is the same as or similar to response relaying module 128, in accordance with one or more implementations.

As noted above, the following co-owned U.S. Pat. No. 17,206,608, entitled “Systems, Methods, Computing Platforms, and Storage Media for Administering a Distributed Edge Computing System Utilizing an Adaptive Edge Engine,” filed Mar. 19, 2021, and now issued as U.S. Pat. No. 11,277,344 ('344 patent) is useful in understanding the present disclosure and its embodiments and is incorporated herein by reference in its entirety and for all practical purposes. The '344 patent describes an Adaptive Edge Engine (AEE), shown as AEE 360 in FIG. 3.

In some cases, the AEE (e.g., AEE 360) of the present disclosure may serve to optimize the deployment of workloads at the edge. In particular, the AEE may facilitate reduced latency, enhanced scalability, as well as reduced network costs by moving processing closer to end users. In some cases, workloads, such as web applications, may be run on endpoints. Endpoints may be hosted in datacenters and may be viewed as an application edge. In some cases, the AEE comprises or works in conjunction with a modular Application Programming Interface (API) for delivery of web applications. In some cases, the AEE 360 aggregates the actions of a plurality of automated components, such as, but not limited to, a location optimizer, a workload-endpoint state store, a workload controller, an endpoint controller, a traffic director, and a health checker. Further, these components may be configured to work without any direct, mutual dependency. In other words, no component requires any other component to function, and each component may be designed, built, and configured to operate independently to deliver collaborative outcomes for customer (or user) workloads.

The basic unit of work for the AEE may be a workload and an endpoint for running the workload. In some cases, a workload may be a tightly-coupled stack of software applications (or modules). In some aspects, a workload may be a basic unit of deployment. Further, an endpoint may be a point of application layer ingress into the module stack, with specific protocols and protocol options available to the connecting customer or client. For simplicity, the stack may be HTTP ingress, a Web Application Firewall, and/or HTTP egress modules. In some aspects, an endpoint may be a server node in a cluster (e.g., node or server 348 of a cluster 369-a). For the purposes of this disclosure, the term “workload” may also be used to refer to a workload-endpoint pair, with the pairing with an endpoint left implicit.

In some cases, the AEE 360 may comprise a workload-endpoint state store (not shown), also referred to as a state store, for coordinating the various components of the AEE. In some cases, the state store may passively coordinate the AEE components, and may comprise a table in a relational database system. Each row in the state store may correspond to a workload or a workload-endpoint pair. Further, the table may comprise one or more columns or data fields, such as, but not limited to, “traffic_direction_desired”, “is_traffic_directed”, “is_healthy”. In some examples, the data fields may take Boolean values, with 1 as affirmative or Yes, and 0 as negative or No. In some cases, the data field “traffic_direction_desired” may also be referred to as “traffic_direction_selected”, and the two may be used interchangeably throughout the application.

In one aspect, the AEE 360 of the present disclosure optimizes deployment of workloads (e.g., applications 491 in FIG. 4) at the network edge. In particular, the AEE 360 facilitates reduced latency and enhanced scalability, reliability, and availability, as well as reduced network costs.

In some cases, the fundamental units of work for the AEE 360 may comprise one or more of workloads, endpoints, and workload-endpoint pairs. As used herein, the term workload may represent a collection of software, often comprising multiple constituent applications, built to run on a server and provide services to client software, e.g., user agents. A user agent, per the World Wide Web Consortium's User Agent Accessibility Guidelines, may refer to any software that retrieves and presents Web content for end users. For example, a workload may comprise a web application. In some other cases, a workload may comprise a collection of mutually-dependent software applications (e.g., web browser applications) built to run on a remote server and connect to user agents through HTTP or other protocols. In some embodiments, the web application may be HTTP ingress, a Web Application Firewall, and/or HTTP egress modules.

In some examples, an endpoint, per the Transmission Control Protocol/Internet Protocol (TCP/IP) model, may refer to a point of application layer ingress into the workload with specific protocols and protocol options available to connecting clients, including user agents. An endpoint is typically an individual server operating singly or as part of a cluster. A computer cluster, such as cluster 369-a, is a collection of connected, coordinated computers (cluster nodes 348) that function as a single server. Some non-limiting examples include a cluster of physical or virtual servers located within a data center.

For the purposes of this disclosure, the term “deploying”, or “deployment” may refer to the process of scheduling and/or installing a workload on an endpoint (e.g., a server or node). Further, a successful deployment is a deployment that results in a properly and completely functioning workload on the given endpoint. Contrastingly, the terms “undeploying” or “undeployment” may refer to the reverse of deploy actions. In one example, undeploying may comprise removing a workload from an endpoint by terminating the instance(s) of the application running on the endpoint, which may serve to free up resources (e.g., computing resources) previously allocated to the workload.

FIG. 3 illustrates a block diagram of a system 300 configured for orchestrating a distributed global computing cluster model and interface using a computing platform, in accordance with various aspects of the disclosure. Additionally, or alternatively, the system 300 is configured for administering a distributed edge computing system using a computing platform, according to various aspects of the disclosure. System 300 implements one or more aspects of the system 100 and/or system 400 described in relation to FIGS. 1 and/or 4, respectively. As seen, system 300 comprises a user device 304 associated with a user 302, a global cluster interface (GCI) 351, and a distributed computing platform 352. The GCI 351 comprises a reconciler 310, an application programming interface (API) server 371, a data store 311, a proxying module 372, and a platform configurator 325. Additionally, the distributed computing platform 352 includes the AEE 360 and an orchestration system 379, where the orchestration system 379 is associated with a plurality of computing clusters 369 (e.g., computing clusters 369-a-d).

One component of this disclosure comprises the Global Cluster Model (GCM). At a basic level, a single computer comprises multiple computing resources such as central processing units (CPUs), random access memory (RAM, or memory), storage discs, etc. Modern operating systems allow users to install and run applications without explicitly concerning themselves with how the various resources are to be used. The operating system manages the resources as part of an integrated system to deliver the intended application experience. A prototypical computing cluster is the next higher-level abstraction of this pattern. The cluster (e.g., local cluster 369-a) is a networked collection of servers or nodes (e.g., shown as nodes 348 in FIG. 3, nodes 448 in FIG. 4), the operation of which is coordinated so that they can be treated as a single computing resource for the deployment of software applications. The system that operates the cluster, such as cluster 369-a, schedules the application (or workload) on specific nodes 348 within the cluster. The GCM elevates this pattern to the next higher level by treating a networked collection of local clusters (i.e., clusters 369-a-d) running in disparate physical locations as a single cluster. In such cases, the local clusters are analogous to nodes and the operation of the global cluster interface (i.e., GCI 351) includes tasks such as scheduling application deployments to the local clusters.

As an operating system manages the operation of a single computer, an orchestration system (e.g., orchestration system 379) manages the operation of one or more cluster(s) 369. In some cases, orchestration system 379 may be embodied in hardware, software, or a combination thereof. For example, the orchestration system 379 may comprise software that creates, operates, manages, and/or destroys the one or more local cluster(s) 369. In some examples, the orchestration system 379 also automates the deployment and operation of containerized applications (e.g., containerized applications or workloads 491 in FIG. 4) at the one or more local cluster(s) 369 (also shown as local clusters 469 in FIG. 4). Given an orchestration system and additional systems to manage actions between and outside of local clusters (i.e., a “platform”), the GCM can be implemented. The GCM 363 is a model for a unified representation of one or more workloads on a distributed network of computing clusters. The GCI 351 is a means of unifying the interactions with a network of distributed computing clusters and the workloads running on it. The GCM 363 and the GCI 351 may not, themselves, provide the many critical functions necessary to create, orchestrate, and operate the workloads or the network. In some circumstances, other systems may be needed to enable implementation of the GCM 363. In one non-limiting example, the GCM 363 may not schedule and run a workload on a cluster. In such cases, an orchestration system, such as orchestration system 379, may be needed to schedule and/or run the workload on the cluster.

In accordance with various aspects of the disclosure, the computing platform may comprise a distributed computing platform 352, where the distributed computing platform 352 utilizes the orchestration system 379 to operate and manage distributed applications (e.g., containerized applications or workloads) across a plurality of computing clusters. In some aspects, the distributed computing platform 352 provides systems and services that interact with the orchestration system 379 to provide a complete, distributed application hosting solution. The distributed computing platform manages aspects of a successful deployment and operation of the workload that exists outside the capabilities of the orchestration system. For example, the distributed computing platform manages the connection of the local clusters 369 to a wider network (e.g., the Internet) while the orchestration system 379 manages network communications within the cluster(s) 369. These two systems (i.e., distributed computing platform 352, orchestration system 379) together enable Internet connectivity to the workloads running in the clusters 369. Some non-limiting examples of orchestration systems (also referred to as container orchestration systems or container orchestration tools) include KUBERNETES and OPENSHIFT, but other container orchestration systems besides the one listed herein are contemplated in different embodiments. That is, the system 300 can be configured to work with other orchestration systems, singly or in combination, known and/or contemplated in the art without departing from the spirit or scope of this disclosure.

In some aspects, the GCM comprises logic to create a unified, global construct out of the individual, local clusters, and constructs defined by the orchestration system 379 and the distributed computing platform 352. In some instances, the GCM can be configured to interpret the constructs of the container orchestration system in a global sense. Another way of stating this is that orchestration systems have constructs for creating and operating individual “local” clusters (e.g., clusters 369-a, 369-b, and 369-c) and for managing workloads on such clusters. An orchestration system may have constructs for a “pod”, a single containerized portion of an application running on a cluster, a “deployment”, a collection of related pods running in a cluster, etc. However, the orchestration system may not have any construct superior to the cluster (i.e., a higher-level or master or global cluster), such as “a collection of clusters”. Any actions taken by the orchestration system 379 may be limited to the scope of just one cluster (e.g., local or computing cluster 369-a). Any representation of a global cluster is the result of configuration of the GCM 363 and its implementation in the GCI 351. Suppose a user 302 is running an application (i.e., a workload) that consists of one deployment containing two (2) pods and this workload is running on two (2) clusters. Further suppose that each pod is actively consuming 0.5 CPU cycles per second. Without the GCM 363, this presents as two distinct clusters, each running one deployment comprising two pods consuming a total of one (1) CPU cycle per second. In some cases, the GCM 363 may be configured to synthesize this information into a single view of the workload on a “global cluster”. Such a view may include one deployment comprising four (4) pods consuming two (2) CPU cycles per second across two (2) global cluster nodes, where each global cluster node is a construct to represent a local cluster (e.g., local cluster(s) 369). In this non-limiting example, the number of pods and the rate of CPU cycles may be additive while the deployment may be non-additive. In some aspects, the GCM 363 supplies the definitions necessary to create a synthetic “global cluster” by synthesizing information and constructs from the different local clusters 369 (e.g., local clusters 369-a-d). If the container orchestration system 379 has one or more constructs superior to the cluster (i.e., cluster of clusters, multi cluster), the GCM 363 may be configured to honor, ignore, override, or otherwise impose different constructs to obtain a global model.

As a further example, a query request may be received at the GCI 351 from the user device, e.g., asking the number of instances of pod ‘A’ that are running. This query request may be routed by the GCI to all individual clusters (e.g., clusters 369-a, 369-b, and 369-c) running the workload. Once the responses (e.g., number of instances of the pod ‘A’) are received by the GCI 351 from each of the individual clusters, the GCM 363 is used to synthesize the information corresponding to the plurality of computing clusters 369-a, 369-b, and 369-c into a global construct. For instance, if there are three (3) replicas of pod ‘A’ running in each of four (4) local clusters, the GCM 363 may interpret this as a total of twelve (12) replicas. In such cases, if the user 302 wishes to access information related to the total number of replicas running across all computing clusters, the GCI 351 may aggregate the data from the plurality of computing clusters, reconcile the data (e.g., based on accessing the model or GCM 363), and provide at least a portion of the reconciled cluster data to the user device 304. In this example, the reconciled cluster data may indicate the total number of replicas (e.g., 12 replicas) running across the plurality of clusters (i.e., clusters 369-a, 369-b, and 369-c). If the user 302 issues a message containing a query requesting specific information from each replica of pod ‘A’, the GCI 351, accessing the GCM 363, can route that message to the individual clusters where instances of pod ‘A’ are running. In yet another example, the GCM 363 may be utilized to pass certain classes of messages (e.g., error messages) directly from the orchestration system 379 to the user 302, i.e., without processing or aggregation, based on determining that the messages are interpretable and actionable as distinct, individual entities.

The GCM 363 can also be configured to inform the distributed computing platform 352 to perceive and interact with the orchestration system 379 and GCM constructs as appropriate. The GCM could be configured such that the adaptive edge engine (AEE) 360 of the distributed computing platform 352 may, for example, choose local clusters 369 for each pod or for the deployment as a whole. In some instances, configurations of this sort may serve to optimize deployment and operation of the application workload. In some instances, the distributed computing platform 352 depends on and interacts with constructs (e.g., logical constructs) of the container orchestration system 379, and the GCM 363 configurations extend and/or interpret these constructs outside of individual, local clusters 369.

In some embodiments, the system 300 also enables the user 302 to define information that helps guide the distributed computing platform 352 in tasks such as, but not limited to, selecting local clusters 369 for the workload or containerized application. For example, the user 302 can express objectives and constraints (e.g., preferences) for choosing specific locations (e.g., local clusters) for their workload. The specification of these preferences can then be consumed by the GCI 351 and passed to the distributed computing platform 352.

In some embodiments, the GCI 351 also serves as an interpretive layer between the user device 304 (or alternatively, the user 302) and the GCM. As illustrated in FIG. 3, on one side of the GCI is the user 302 (e.g., application developer or operator), where the GCI 351 enables the user 302 to define and deploy applications (e.g., shown as applications 491 in FIG. 4), monitor their function, access internal information and operations of the applications, and create/destroy/alter application deployments as needed. Additionally, on the other side of the GCI is the distributed computing platform 352 and a network of local clusters 369.

In some examples, the distributed computing platform 352 utilizes an adaptive edge engine 360, where the adaptive edge engine 360 implements one or more aspects of the adaptive edge engine (AEE) described in the '344 patent. In some cases, the distributed computing platform 352, via the adaptive edge engine 360 (or AEE 360), chooses one or more local clusters 369 for at least one workload, deploys the at least one workload to the one or more clusters 369, monitors a health status for each workload-cluster combination, and routes internet traffic to the at least one workload-cluster combination (e.g., based on determining that the health status is healthy). In some embodiments, the local clusters 369 are implemented by an orchestration system 379 and the GCI 351 can interface with these clusters 369 directly, according to the GCM, for certain actions such as, but not limited to, changes to the workload configuration, information queries, etc. As an example, the application or workload may comprise a node.JS application (e.g., a website). If a new version (e.g., comprising a change in software code) is rolled out, the GCI is configured to push a new definition of the node.JS container. To ensure consistency between the plurality of clusters 369 running the workload, the new workload configuration (i.e., associated with the updated node.JS container) is pushed out to all clusters running the workload.

As depicted in FIG. 3, the model 363 (or GCM 363) may be implemented at the GCI 351, the distributed computing platform 352, and/or the adaptive edge engine 360. The dashed-lines around the model 363 are intended to illustrate that the model 363 may be deployed at, or across, the one or more locations shown in FIG. 3. In some embodiments, the GCI 351 relays commands, as defined by the orchestration system, across the global cluster (i.e., local clusters 369-a-d). In some examples, the command comprises an instruction to delete at least one container associated with the containerized application or workload. Alternatively, the command comprises an instruction to update, e.g., push code changes to or query information from at least one container associated with the containerized application. After issuing the command, the GCI 351 collects and presents appropriate results (e.g., at least a portion of the reconciled cluster data) according to the GCM 363.

For example, in a single cluster deployment, the user may issue a command to see output logs from a particular container (e.g., KUBERNETES pod). However, with the GCI, the user 302 can issue the same command and obtain similar results despite the fact that there may be multiple copies of the particular container running in disparate locations (e.g., clusters located at different geographic locations, in different data centers, etc.) around the globe. In some aspects, the GCM 363 defines how the information will be synthesized, while the GCI 351 provides the tooling to access it. Without the GCI, the user would have to know specific addressing information for a plurality of containers in every location (e.g., cluster) where an instance of the containerized application is running and issue unique commands for each instance and location. The GCI enables the user 302 to obtain the same or similar information (e.g., cluster data) with fewer commands, query requests, etc. In some examples, the user 302 may not even know where or how many instances of the container are running and/or which specific node is running the workload when they query information or issue commands.

In some embodiments, the GCI 351 comprises one or more of the API system 371 (e.g., a user-facing API system), a data store 311, a reconciler 310 (or reconciling module 310), a platform configurator 325, and an orchestrator proxying module 372. The API system 371 may comprise an interface-API server, as well as supporting systems, to facilitate in communications between the user device 304 and one or more of the GCI 351, the distributed computing platform 352, the orchestration system 379, and/or the AEE 360. The data store 311 (also referred to as data collection and storage system 311) is configured to collect, store, and/or aggregate container data from the plurality of local clusters 369. In some cases, the reconciler 310 is configured to translate the data collected from the plurality of clusters 369 into reconciled cluster data, where the translation is based at least in part on the model 363. That is, the reconciler 310 facilitates translating workload/container data from the clusters 369 into the unified form (i.e., a coherent and integrated “global cluster” representation) that can be presented to the user 302. The platform configurator 325 is configured to interact with the distributed computing platform 352 and/or the AEE 360, for instance, to update a configuration for at least one container associated with the containerized application and/or delete at least one container associated with the containerized application or workload, to name two non-limiting examples. The platform configurator 325 helps translate and relay one or more commands (e.g., received from the user device 304) to a form that is interpretable by the distributed computing platform 352. The commands may be associated with a workload update (e.g., when a new version of the workload or application is ready to be deployed), a configuration update for the workload, and any other relevant communications between the user device 304 and the distributed computing platform 352.

In some cases, the orchestrator proxying module 372 implements one or more aspects of the target recipient identifying module 122, message proxying module 124, response receiving module 126, and/or the response relaying module 128, as previously described in relation to FIG. 1. The orchestrator proxying module 372 is configured to proxy API-server commands (and other applicable messages) to the local clusters 369, for instance, via the orchestration system 379. As an example, one or more messages may be received at the GCI 351 from the user device 304, where the one or more messages may comprise one or more of a query request and a command. The orchestrator proxying module 372 may receive the one or more messages directly or indirectly (e.g., via the API module 371) and identify a target recipient for each of the one or more messages. For instance, the orchestrator proxying module 372 may identify a target recipient for a first one of the one or more messages, wherein the target recipient comprises one of the orchestration system 379, at least one of the plurality of computing clusters 369, the distributed computing platform 352, or the data store 311. Then, the orchestrator proxying module 372 proxies the first one of the messages to the target recipient. In some cases, proxying the first one of the messages comprises translating the first one of the messages into a form that is interpretable by the target recipient, and relaying the translated first one of the one or more messages to the target recipient. In other cases, the orchestrator proxying module 372 directly proxies (i.e., without translation) the first one of the messages to the target recipient. As an example, if the message comprises a KUBERNETES specific command, the orchestrator proxying module 372 may skip the translation step and directly relay the message to the container orchestration system 379. In some embodiments, the GCI 351 may also implement one or more other operational requirements (e.g., TLS certificate management, logs, metrics, etc.) for supporting and/or administering the distributed edge computing system.

In some cases, users (e.g., user 302) of the GCI 351 may directly interact with the interface-apiserver system (e.g., shown as API system 371). The API system 371 is embodied in hardware, software, or a combination thereof, and includes components to support information transfer (e.g., HTTP ingress endpoints). The messages (e.g., commands and/or query requests) received by the API system 371 are validated and verified via calls to supporting services (e.g., validation webhook). As noted above, commands can include, but are not limited to, commands that are proxied to individual clusters 369, commands used to interact with the distributed computing platform 352, and/or commands used to interact with the data store 311. While not necessary, in some cases, behavior within the local clusters 369 is handled by the orchestration system 379. Additional behaviors may fall in the domain of the distributed computing platform 352 and/or the AEE 360. The AEE 360, subject to user inputs (e.g., latency objectives, budget constraints, location constraints, etc.), identifies the local clusters 369 within which the workload should run, facilitates in deployment and undeployment of workloads, evaluates the healthiness of the workload instances, and manages the direction of internet traffic to the one or more workload instances, to name a few non-limiting examples. In some cases, the one or more user inputs or preferences may be packaged into strategies (e.g., operational and/or functional strategies) and passed to the AEE 360. In some examples, the one or more operational and functional strategies are based at least in part on one or more of default strategies, operational preferences, customer or client preference data, etc.

As described in the '344 patent, the AEE 360 may access one or more of operational strategies that define how the AEE (or a subcomponent of the AEE) operates and interacts with a fundamental unit of work (e.g., a workload, a workload-endpoint pair, a datacenter or endpoint-hosting facility, etc.). An operational strategy, for example, may specify that a subcomponent of AEE 360 runs as multiple parallel instances, taking work signals from one or more message queues. Another exemplary operational strategy may direct the subcomponent of the AEE 360 to operate as a single instance iterating through a list of work items. Thus, operational strategies may define how the component gets its work (e.g., how the component is allocated its work, assigned its work, etc.).

In other cases, the user input may comprise one or more other strategies, such as functional strategies, where the strategies pertain to how a subcomponent of the AEE 360 performs the work (i.e., the strategies may govern how the subcomponent does its work).

In some cases, workload information for the at least one workload is collected from the plurality of computing clusters (or plurality of endpoints). Additionally, the system (e.g., system 100, system 300) aggregates the data (e.g., workload information) from the plurality of computing clusters and stores said data to the data store 311. The data store 311 makes this data available for use by other components/elements of the GCI 351, the distributed computing platform 352, and/or the user device 304. In some cases, the data store 311 stores information related to the state of the workload (e.g., is workload running or not running, is workload ready or not ready), computational resource usage information (e.g., memory usage, such as RAM usage information), and any other applicable information (e.g., container data from multiple clusters) for the at least one workload running on the plurality of computing clusters 369. Thus, the GCI 351 includes the data store 311 and implements processes to fetch and collect data about the state of the workload (e.g., is application running) across the plurality of local cluster 369 instances (e.g., clusters 369-a, 369-b, 369-c, and/or 369-d). As compared to the prior art, where a user may need to directly interact with each local cluster to obtain information about the workload, the GCI allows the user to interact at a single point to access workload information, container data, state data for the at least one workload, etc.

As used herein, the term “reconciliation” refers to the function of actively implementing the GCM 363. In some cases, data is collected from the plurality of computing clusters 369, where the data includes workload information for at least one workload running on the plurality of clusters 369, information related to objects and/or constructs specific to the orchestration system, information related to objects and/or constructs specific to the distributed computing platform 352, container data (e.g., if the workload comprises a containerized application), state data for the at least one workload, etc. Additionally, the reconciler module 310 (or another module of the GCI 351) accesses the GCM 363 and reconciles one or more of the data from the data store 311 and state data for the at least one workload to create reconciled cluster data. In some cases, the reconciling is based at least in part on accessing the GCM 363. Reconciling may include translating the data collected from the plurality of computing clusters and the state data into a SSOT for a corresponding workload state for the at least one workload running across the plurality of computing clusters 369. That is, the GCM 363 is used for synthesizing information corresponding to the plurality of computing clusters and the orchestration system into a global construct, where the information comprises at least the data collected from the plurality of computing clusters and/or the data specific to the orchestration system. In some examples, the global construct is utilized to generate the SSOT of the corresponding workload state (e.g., is application running, CPU resource usage information, etc.) for the at least one workload across the plurality of computing clusters 369. In some cases, reconciliation is performed on the aggregated data (e.g., data stored in the data store 311) and provided to the API server (or API module 371) as needed.

As shown in FIG. 3, the GCI 351 comprises the platform configurator 325 (also referred to as translator 325) for translating any relevant user inputs (e.g., commands or instructions, query requests) to a form that is interpretable by the distributed computing platform 352. This enables the distributed computing platform 352 to invoke one or more processes or functions based on the user inputs received at the GCI 351. As an example, the distributed computing platform 352 (or hosting platform 352) may be utilized to create and destroy workloads or perform other operations external to the GCI 351 and/or the orchestration system 379. In some cases, the AEE 360 of the distributed computing platform 352 is configured to receive one or more user inputs, such as, but not limited to, workload configurations that influence where and when a workload is deployed, operational strategies, functional strategies, or any other AEE-specific functions. In some cases, the platform configurator 325 is configured to translate the one or more user inputs before relaying them to the AEE 360 and/or hosting platform 352. In other cases, the one or more user inputs are directly proxied to the target recipient (e.g., AEE 360), without any intermediate translation by the platform configurator 325.

The GCI 351 also interfaces with the orchestration system 379. The GCI 351 is configured to deliver commands, e.g., on behalf of the user 302, to the orchestration system 379 and collect data about the workload instances running in the local clusters 369. The GCI 351 includes a proxy 372 that allows the user 302 (or user device 304) to interact indirectly with the orchestration system 379, where the interaction may be subject to the GCM 363 implemented by the GCI 351. For example, the orchestration system may offer a command ‘X’ that returns a list of all pods running in a cluster. When the user issues command ‘X’, the GCI proxies this command to each local cluster, reconciles the responses from the clusters according to the GCM, and presents the reconciled results to the user. The interaction is indirect due to the implementation of the GCM 363, but the user experience is identical or substantially identical to that of a user interacting directly with a single cluster.

The GCI 351 also comprises additional systems as necessary to ensure adequate functionality and appropriate user experience. Some non-limiting examples of such systems may include, for example, a TLS certificate management system for network connections using HTTPS protocol, systems to collect, transport, store, and/or deliver metrics and logs from one or more other subsystems and components of the system 300.

FIG. 4 illustrates another block diagram of a system 400 configured to orchestrate a distributed global computing cluster model and interface using a computing platform, according to various aspects of the disclosure. In some implementations, the system 400 is configured to administer a distributed edge computing system using a distributed computing platform 452 (or hosting platform 452), according to various aspects of the disclosure. The system 400 implements one or more aspects of the system(s) 100 and/or 300 described in relation to FIGS. 1 and/or 3, respectively. The system 400 comprises a global cluster interface (GCI) 451 that implements one or more aspects of the GCI 351 described in relation to FIG. 3. Additionally, the GCI 451 is electronically, logically, and/or communicatively coupled to an orchestration system 479, the distributed computing platform 452, and one or more applications 491 (i.e., workloads).

In some circumstances, the one or more applications 491 comprise containerized applications that are associated with the orchestration system 479 (e.g., container orchestration system, such as KUBERNETES or OPENSHIFT). The GCI 451 serves as an intermediary between the applications 491 and the distributed computing platform 452, as previously described in relation to FIGS. 1-3. Additionally, or alternatively, the GCI 451 serves as an intermediary between the applications 491 and the orchestration system 479. As seen, the orchestration system 479 and/or the hosting platform 452 are configured to communicate with a plurality of local clusters 469 using data flows 446 and/or 447, respectively. Here, data flows 446 and 447 split off into data flows 445-d, 445-e, and 445-f. Each of data flows 445-d, 445-e, and 445-f represent the bi-directional flow of data between a respective cluster 469, and the orchestration system 479 and the hosting platform 452. In some cases, each local cluster 469 (e.g., local cluster 469-a, 469-b, 469-c) comprises a plurality of nodes or servers 448. Furthermore, the GCI 451 is configured to communicate with the one or more application(s) 491 using bi-directional data flows 445 (e.g., data flows 445-a, 445-b, 445-c).

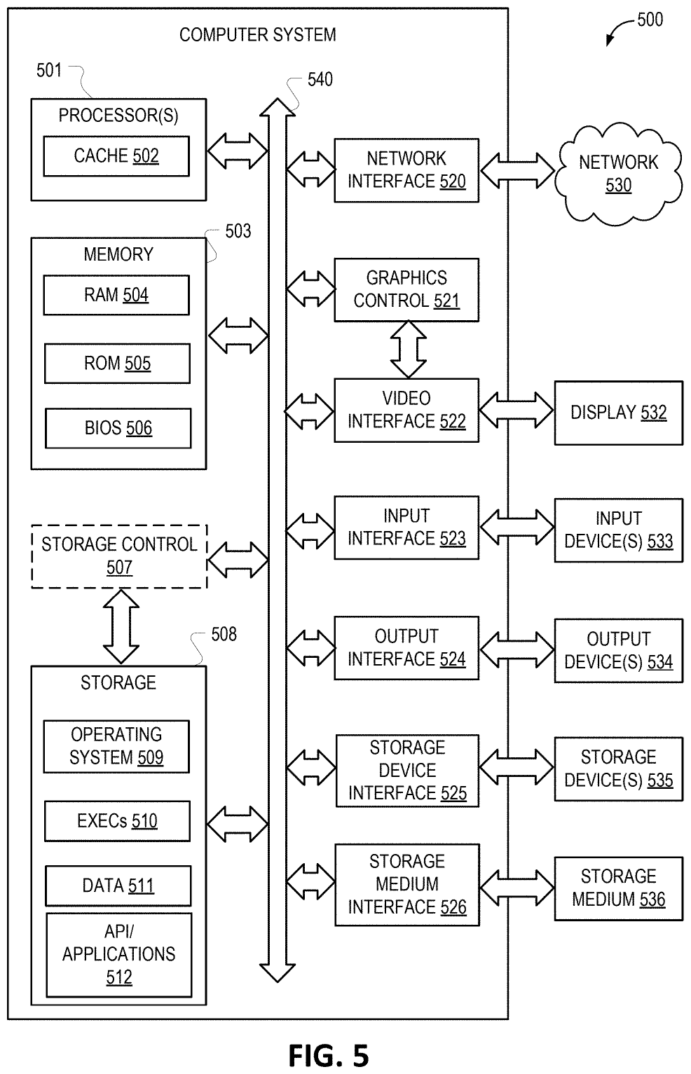

FIG. 5 illustrates a diagrammatic representation of one embodiment of a computer system 500, within which a set of instructions can execute for causing a device to perform or execute any one or more of the aspects and/or methodologies of the present disclosure. Specifically, but without limitation, the computer system 500 is configured to orchestrate a distributed global computing cluster model and interface, in accordance with one or more implementations. The components in FIG. 5 are examples only and do not limit the scope of use or functionality of any hardware, software, firmware, embedded logic component, or a combination of two or more such components implementing particular embodiments of this disclosure. Some or all of the illustrated components can be part of the computer system 500. For instance, the computer system 500 can be a general-purpose computer (e.g., a laptop computer) or an embedded logic device (e.g., an FPGA), to name just two non-limiting examples.

Moreover, the components may be realized by hardware, firmware, software or a combination thereof. Those of ordinary skill in the art in view of this disclosure will recognize that if implemented in software or firmware, the depicted functional components may be implemented with processor-executable code that is stored in a non-transitory, processor-readable medium such as non-volatile memory. In addition, those of ordinary skill in the art will recognize that hardware such as field programmable gate arrays (FPGAs) may be utilized to implement one or more of the constructs depicted herein.

Computer system 500 includes at least a processor 501 such as a central processing unit (CPU) or a graphics processing unit (GPU) to name two non-limiting examples. Any of the subsystems described throughout this disclosure could embody the processor 501. The computer system 500 may also comprise a memory 503 and a storage 508, both communicating with each other, and with other components, via a bus 540. The bus 540 may also link a display 532, one or more input devices 533 (which may, for example, include a keypad, a keyboard, a mouse, a stylus, etc.), one or more output devices 534, one or more storage devices 535, and various non-transitory, tangible computer-readable storage media 536 with each other and/or with one or more of the processor 501, the memory 503, and the storage 508. All of these elements may interface directly or via one or more interfaces or adaptors to the bus 540. For instance, the various non-transitory, tangible computer-readable storage media 536 can interface with the bus 540 via storage medium interface 526. Computer system 500 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 501 (or central processing unit(s) (CPU(s))) optionally contains a cache memory unit 502 for temporary local storage of instructions, data, or computer addresses. Processor(s) 501 are configured to assist in execution of computer-readable instructions stored on at least one non-transitory, tangible computer-readable storage medium. Computer system 500 may provide functionality as a result of the processor(s) 501 executing software embodied in one or more non-transitory, tangible computer-readable storage media, such as memory 503, storage 508, storage devices 535, and/or storage medium 536 (e.g., read only memory (ROM) 505). Memory 503 may read the software from one or more other non-transitory, tangible computer-readable storage media (such as mass storage device(s) 535, 536) or from one or more other sources through a suitable interface, such as network interface 520. Any of the subsystems herein disclosed could include a network interface such as the network interface 520. The software may cause processor(s) 501 to carry out one or more processes or one or more steps of one or more processes described or illustrated herein, such as the method(s) 200 described in relation to FIGS. 2A-2D. Carrying out such processes or steps may include defining data structures stored in memory 503 and modifying the data structures as directed by the software. In some embodiments, an FPGA can store instructions for carrying out functionality as described in this disclosure. In other embodiments, firmware includes instructions for carrying out functionality as described in this disclosure.

The memory 503 may include various components (e.g., non-transitory, tangible computer-readable storage media) including, but not limited to, a random-access memory component (e.g., RAM 504) (e.g., a static RAM “SRAM”, a dynamic RAM “DRAM, etc.), a read-only component (e.g., ROM 505), and any combinations thereof. ROM 505 may act to communicate data and instructions unidirectionally to processor(s) 501, and RAM 504 may act to communicate data and instructions bidirectionally with processor(s) 501. ROM 505 and RAM 504 may include any suitable non-transitory, tangible computer-readable storage media. In some instances, ROM 505 and RAM 504 include non-transitory, tangible computer-readable storage media for carrying out a method, such as method(s) 200 described in relation to FIGS. 2A-2D. In one example, a basic input/output system 506 (BIOS), including basic routines that help to transfer information between elements within computer system 500, such as during start-up, may be stored in the memory 503.

Fixed storage 508 is connected bi-directionally to processor(s) 501, optionally through storage control unit 507. Fixed storage 508 provides additional data storage capacity and may also include any suitable non-transitory, tangible computer-readable media described herein. Storage 508 may be used to store operating system 503, EXECs 510 (executables), data 511, API applications 512 (application programs), and the like. Often, although not always, storage 508 is a secondary storage medium (such as a hard disk) that is slower than primary storage (e.g., memory 503). Storage 508 can also include an optical disk drive, a solid-state memory device (e.g., flash-based systems), or a combination of any of the above. Information in storage 508 may, in appropriate cases, be incorporated as virtual memory in memory 503.

In one example, storage device(s) 535 may be removably interfaced with computer system 500 (e.g., via an external port connector (not shown)) via a storage device interface 525. Particularly, storage device(s) 535 and an associated machine-readable medium may provide nonvolatile and/or volatile storage of machine-readable instructions, data structures, program modules, and/or other data for the computer system 500. In one example, software may reside, completely or partially, within a machine-readable medium on storage device(s) 535. In another example, software may reside, completely or partially, within processor(s) 501.

Bus 540 connects a wide variety of subsystems. Herein, reference to a bus may encompass one or more digital signal lines serving a common function, where appropriate. Bus 540 may be any of several types of bus structures including, but not limited to, a memory bus, a memory controller, a peripheral bus, a local bus, and any combinations thereof, using any of a variety of bus architectures. As an example, and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 500 may also include an input device 533. In one example, a user of computer system 500 may enter commands and/or other information into computer system 500 via input device(s) 533. Examples of an input device(s) 533 include, but are not limited to, an alpha-numeric input device (e.g., a keyboard), a pointing device (e.g., a mouse or touchpad), a touchpad, a touch screen and/or a stylus in combination with a touch screen, a joystick, a gamepad, an audio input device (e.g., a microphone, a voice response system, etc.), an optical scanner, a video or still image capture device (e.g., a camera), and any combinations thereof. Input device(s) 533 may be interfaced to bus 540 via any of a variety of input interfaces 523 (e.g., input interface 523) including, but not limited to, serial, parallel, game port, USB, FIREWIRE, THUNDERBOLT, or any combination of the above.

In particular embodiments, when computer system 500 is connected to network 530, computer system 500 may communicate with other devices, such as mobile devices and enterprise systems, connected to network 530. Communications to and from computer system 500 may be sent through network interface 520. For example, network interface 520 may receive incoming communications (such as requests or responses from other devices, for instance, user instructions or commands, query requests, etc., from a user device) in the form of one or more packets (such as Internet Protocol (IP) packets) from network 530, and computer system 500 may store the incoming communications in memory 503 for processing. Computer system 500 may similarly store outgoing communications (such as requests or responses to other devices, reconciled cluster data associated with a plurality of local computing clusters, etc.) in the form of one or more packets in memory 503 and communicated to network 530 from network interface 520. Processor(s) 501 may access these communication packets stored in memory 503 for processing.

Examples of the network interface 520 include, but are not limited to, a network interface card, a modem, and any combination thereof. Examples of a network 530 or network segment 530 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 530, may employ a wired and/or a wireless mode of communication. In general, any network topology may be used.

Information and data can be displayed through a display 532. Examples of a display 532 include, but are not limited to, a liquid crystal display (LCD), an organic liquid crystal display (OLED), a cathode ray tube (CRT), a plasma display, and any combinations thereof. The display 532 can interface to the processor(s) 501, memory 503, and fixed storage 508, as well as other devices, such as input device(s) 533, via the bus 540. The display 532 is linked to the bus 540 via a video interface 522, and transport of data between the display 532 and the bus 540 can be controlled via the graphics control 521.

In addition to a display 532, computer system 500 may include one or more other peripheral output devices 534 including, but not limited to, an audio speaker, a printer, etc. Such peripheral output devices may be connected to the bus 540 via an output interface 524. Examples of an output interface 524 include, but are not limited to, a serial port, a parallel connection, a USB port, a FIREWIRE port, a THUNDERBOLT port, and any combinations thereof.

In addition, or as an alternative, computer system 500 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an integrated circuit or IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, a software module implemented as digital logic devices, or in a combination of these. A software module may reside in RAM memory (e.g., RAM 504), flash memory, ROM memory (e.g., ROM 505), EPROM memory, EEPROM memory, registers, hard disk, a removable disk, a CD-ROM, or any other form of non-transitory, tangible computer-readable storage medium known in the art. An exemplary non-transitory, tangible computer-readable storage medium is coupled to the processor 501 (also shown as processor 134 in FIG. 1) such that the processor 501 can read information from, and write information to, the non-transitory, tangible computer-readable storage medium. In the alternative, the non-transitory, tangible computer-readable storage medium may be integral to the processor 501. The processor 501 and the non-transitory, tangible computer-readable storage medium may reside in an ASIC. In some examples, the ASIC may reside in a user terminal. In the alternative, the processor and the non-transitory, tangible computer-readable storage medium may reside as discrete components in a user terminal. In some embodiments, a software module may be implemented as digital logic components such as those in an FPGA once programmed with the software module.

It is contemplated that one or more of the components or subcomponents described in relation to the computer system 500 shown in FIG. 5 such as, but not limited to, the network 530, processor 501, memory 503, etc., may comprise a cloud computing system. In one such system, front-end systems such as input devices 533 may provide information to back-end platforms such as servers (e.g., API server 371, nodes or servers 348 of computing clusters 369, proxying module or server 372, distributed computing platform 352, AEE 360, computer system(s) 100 and/or 500, etc.) and storage (e.g., memory 503). Software (i.e., middleware) may enable interaction between the front-end and back-end systems, with the back-end system providing services and online network storage to multiple front-end clients. For example, a software-as-a-service (SAAS) model may implement such a cloud-computing system. In such a system, users may operate software located on back-end servers through the use of a front-end software application such as, but not limited to, a web browser.

Processor 501, also shown as processor 134 in FIG. 1, may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 501 may be configured to operate a memory array using a memory controller. In other cases, a memory controller may be integrated into the processor. The processor 501 or processor 134 may be configured to execute computer-readable instructions stored in memory to perform various functions (e.g., functions or tasks supporting administration of a distributed edge computing system). Memory 503, also shown as electronic storage 132 in FIG. 1, may include random access memory (RAM) and read only memory (ROM). The memory may store computer-readable, computer-executable software including instructions that, when executed, cause the processor 501 to perform various functions described herein. In some cases, the memory may contain, among other things, a basic input/output system (BIOS) which may control basic hardware and/or software operation such as the interaction with peripheral components or devices.

Software may include code to implement aspects of the present disclosure, including code for orchestrating a distributed global computing cluster model and interface (or alternatively, administering a distributed edge computing system) using a computing platform (e.g., distributed computing platform 352). Software may be stored in a non-transitory computer-readable medium such as system memory or other memory. In some cases, the software may not be directly executable by the processor but may cause a computer (e.g., when compiled and executed) to perform functions described herein.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

### ADDITIONAL EMBODIMENTS

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

In one aspect, the Global Cluster Interface (GCI) of the present disclosure, such as GCI 351 in FIG. 3, implements a Global Cluster Model (GCM), such as model 363.

Another aspect of the present disclosure relates to a system configured for administering a distributed edge computing system utilizing a GCI, such as, but not limited to, GCI 351 in FIG. 3.

Yet another aspect of the present disclosure relates to a computing platform configured for administering a distributed edge computing system utilizing a GCI. The computing platform may include a non-transient computer-readable storage medium having executable instructions embodied thereon. The computing platform may include one or more hardware processors configured to execute said instructions.

Even another aspect of the present disclosure relates to a non-transient computer-readable storage medium having instructions embodied thereon, the instructions being executable by one or more processors to perform a method for administering a distributed edge computing system utilizing an adaptive edge engine.

1. A system configured for administering a distributed edge computing system using a computing platform, the system comprising:
one or more hardware processors configured by machine-readable instructions to:
identify a plurality of computing clusters running at least one workload, wherein the plurality of computing clusters are associated with an orchestration system;
collect data from the plurality of computing clusters, wherein the data comprises workload information for the at least one workload;
aggregate the data from the plurality of computing clusters, wherein the aggregating further comprises storing the data to a data store;
access a model;
reconcile, based at least in part on accessing the model, one or more of the data from the data store and state data for the at least one workload to create reconciled cluster data;
receive one or more messages from a user device, wherein the one or more messages comprise one or more of a query request and a command; and
in response to receiving the one or more messages from the user device, provide at least a portion of the reconciled cluster data to the user device.

2. The system of claim 1, wherein the reconciling to create the reconciled cluster data comprises:
translating, based at least in part on accessing the model, the data collected from the plurality of computing clusters and the state data into a single source of truth (S SOT) for a corresponding workload state for the at least one workload across the plurality of computing clusters.

3. The system of claim 2, wherein:
the model is used for synthesizing information corresponding to the plurality of computing clusters and the orchestration system into a global construct;
the information comprises at least the data collected from the plurality of computing clusters and data specific to the orchestration system; and
the global construct is utilized to generate the SSOT of the corresponding workload state for the at least one workload across the plurality of computing clusters.

4. The system of claim 1, wherein the computing platform is electronically, logically, or communicatively coupled to the orchestration system associated with the plurality of computing clusters and a global cluster interface (GCI), wherein the GCI comprises at least the data store and an application programming interface (API) for communications with the user device.

5. The system of claim 1, wherein prior to providing at least a portion of the reconciled cluster data to the user device,
the one or more hardware processors are further configured by machine-readable instructions to:
identify a target recipient for a first one of the one or more messages, wherein the target recipient comprises one of the orchestration system, at least one of the plurality of computing clusters, the computing platform, or the data store; and
proxy the first one of the one or more messages to the target recipient.

6. A method for administering a distributed edge computing system using a computing platform, the method comprising:
identifying a plurality of computing clusters running at least one workload, wherein the plurality of computing clusters are associated with an orchestration system;
collecting data from the plurality of computing clusters, wherein the data comprises workload information for the at least one workload;
aggregating the data from the plurality of computing clusters, wherein the aggregating further comprises storing the data to a data store;
accessing a model;
reconciling, based at least in part on accessing the model, one or more of the data from the data store and state data for the at least one workload to create reconciled cluster data;
receiving one or more messages from a user device, wherein the one or more messages comprise one or more of a query request and a command; and
in response to receiving the one or more messages from the user device, providing at least a portion of the reconciled cluster data to the user device.

7. The method of claim 6, wherein the reconciling to create the reconciled cluster data comprises translating, based at least in part on accessing the model, the data collected from the plurality of computing clusters and the state data into a single source of truth (SSOT) for a corresponding workload state for the at least one workload across the plurality of computing clusters.

8. The method of claim 7, wherein:
the model is used for synthesizing information corresponding to the plurality of computing clusters and the orchestration system into a global construct;
the information comprises at least the data collected from the plurality of computing clusters and data specific to the orchestration system; and
the global construct is utilized to generate the SSOT of the corresponding workload state for the at least one workload across the plurality of computing clusters.

9. The method of claim 6, wherein the computing platform is electronically, logically, or communicatively coupled to the orchestration system associated with the plurality of computing clusters, and a global cluster interface (GCI), wherein the GCI comprises at least the data store and an application programming interface (API) for communications with the user device.

10. The method of claim 6, wherein prior to providing at least a portion of the reconciled cluster data to the user device, the method further comprises:
identifying a target recipient for a first one of the one or more messages, wherein the target recipient comprises one of the orchestration system, at least one of the plurality of computing clusters, the computing platform, or the data store; and
proxying the first one of the one or more messages to the target recipient.

11. The method of claim 10, wherein:
proxying the first one of the one or more messages further comprises translating the first one of the one or more messages into a form that is interpretable by the target recipient; and
proxying the first one of the one or more messages further comprises relaying the translated first one of the one or more messages to the target recipient.

12. The method of claim 10, further comprising:
receiving a response from a corresponding one of the orchestration system, the at least one of the plurality of computing clusters, the data store, or the computing platform, wherein the response comprises at least information used to create the reconciled cluster data.

13. The method of claim 12, further comprising:
relaying the response to the user device.

14. The method of claim 6, wherein:
the at least one workload comprises a containerized application,
the collected data comprises container data, and
the orchestration system is a container orchestration system, the container orchestration system comprising one or more of a logical construct and a software construct.

15. The method of claim 14, wherein the plurality of computing clusters comprise a plurality of nodes or servers in communication over a network, and wherein the container orchestration system schedules deployment of the at least one workload on one or more of the plurality of nodes or servers of the plurality of computing clusters.

16. The method of claim 14, wherein the model comprises logic for interpreting one or more of data collected from the plurality of computing clusters, one or more of the logical construct and the software construct of the container orchestration system, one or more objects associated with the container orchestration system, and one or more objects associated with the computing platform.

17. The method of claim 16, wherein the container orchestration system comprises a Kubernetes container orchestration system.

18. The method of claim 16, wherein each one of the plurality of computing clusters is running an instance of the at least one workload, and wherein one or more of:
the query request comprises a request for a status update on the at least one workload running across the plurality of computing clusters, wherein the status update comprises one of a Ready status or Not Ready status;
the query request comprises a request for computational resource usage information for the at least one workload running across the plurality of computing clusters;
the command comprises an instruction to delete at least one container associated with the containerized application; and
the command comprises an instruction to update a configuration for at least one container associated with the containerized application.

19. A non-transient computer-readable storage medium having instructions embodied thereon, the instructions being executable by one or more processors to perform a method for administering a distributed edge computing system using a computing platform, the method comprising:
identifying a plurality of computing clusters running at least one workload, wherein the plurality of computing clusters are associated with an orchestration system;
collecting data from the plurality of computing clusters, wherein the data comprises workload information for the at least one workload;
aggregating the data from the plurality of computing clusters, wherein the aggregating further comprises storing the data to a data store;
accessing a model;
reconciling, based at least in part on accessing the model, one or more of the data from the data store and state data for the at least one workload to create reconciled cluster data;
receiving one or more messages from a user device, wherein the one or more messages comprise one or more of a query request and a command; and
in response to receiving the one or more messages from the user device, providing at least a portion of the reconciled cluster data to the user device.

20. The computer-readable storage medium of claim 19, wherein the reconciling to create the reconciled cluster data comprises:
translating, based at least in part on accessing the model, the data collected from the plurality of computing clusters and the state data into a single source of truth (SSOT) for a corresponding workload state for the at least one workload across the plurality of computing clusters.
